(19) United States
(12) Patent Application Publication
(10) Pub. No.: US 2010/0042518 A1
(43) Pub. Date: Feb. 18, 2010

(54) PAYROLL RULES ENGINE FOR POPULATING PAYROLL COSTING ACCOUNTS

(75) Inventors: Neerav Handa, Sunnyvale, CA (US); Andrew Logue, Reading (GB); Venkataramana Dharmapuri, Fremont, CA (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/191,602

(22) Filed: Aug. 14, 2008

(51) Int. Cl. G06Q 10/00

(52) U.S. Cl. 705/30

(57) ABSTRACT

Systems and methods are disclosed for using rules to populate a payroll cost account. An embodiment includes receiving a request to create a new payroll rule, displaying a rule creation user interface to a user, receiving a rule definition for the new payroll rule, generating the new payroll rule, and applying the payroll rule to payroll data.

### FIELD OF THE INVENTION

One embodiment is directed generally to enterprise application systems, and more particularly to payroll cost management.

### BACKGROUND INFORMATION

Payroll accounting is a process with which employers, accountants and payroll agencies determine and distribute wages to an employee as well as handle vacation and sick time accumulation. The payroll process takes into account certain taxable payments, such as salary, bonuses, advance payments and overtime, and non-taxable payments, such as employee expenses and employer pension contributions. The payroll process also takes into account certain pre-tax deductions and post-tax deductions, such as employee pension contributions and health care costs. Furthermore, the payroll process also takes into account certain benefits, credits and charges. Due to the complexity of calculating wages, withholdings and credits for employees, many employers, accountants and payroll agencies use a third party calculation system or application software to prepare the payroll for the company.

Payroll calculation systems provide automated payroll solutions for calculating an employee's net pay. Calculating an employee's net pay differs from jurisdiction to jurisdiction and geography to geography (e.g., country to country, state to state, city to city, etc.). The differences in calculating net pay in different jurisdictions includes elements of employee income subject to various taxes or deductions, the calculation of tax and deductions as well as applying taxes and deductions. The complexity and variance of these payroll requirements in different jurisdictions makes generically calculating pay across many jurisdictions very challenging.

Further adding to the complexity of payroll calculation systems is existence of multiple funds from which to pay the employee. For example, the pay afforded an employee from project A should be attributed as a cost to the funds for project A. Similarly, work done under an institutional grant should be billed to an account for that grant. The complexity and variance of these cost requirements across multiple accounts makes generically accounting for payroll costs very challenging.

### SUMMARY OF THE INVENTION

One embodiment is a method for using rules to populate a payroll cost account. The method includes receiving a request to create a new payroll rule, displaying a rule creation user interface to a user, receiving a rule definition for the new payroll rule, generating the new payroll rule, and applying the payroll rule to payroll data.

### BRIEF DESCRIPTION OF THE DRAWINGS

FIG. 1 is a block diagram of one computing environment in which some embodiments may be practiced;

FIG. 2 is payroll rules engine system in accordance with an embodiment;

FIG. 3 is an example search user interface in accordance with an embodiment;

FIG. 4A is an example edit user interface in accordance with an embodiment;

FIG. 4B is a continuation of the example edit user interface in accordance with an embodiment; and

FIG. 5 is a flow diagram depicting a method using rules to populate a payroll costing account in accordance with an embodiment.

### DETAILED DESCRIPTION

An embodiment is directed to a payroll costing system that allows a user to define payroll rules to assign payroll costs to various accounts. A payroll rule is, for example, a prescribed guide for calculating aspects of an employee's pay, as well as determining to which funding source the organizational cost of that pay should be assigned. Thus, payroll costs may be automatically allocated to the correct billing or charge account based on satisfying conditions of the rules. Accordingly, a user is not required to manually assign payroll costs to specific accounts.

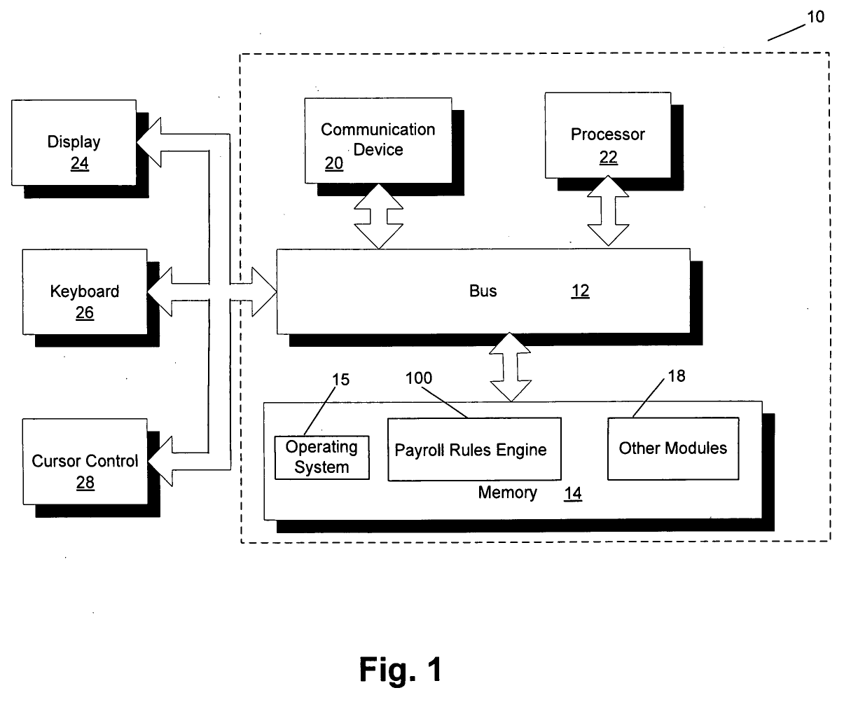

FIG. 1 is a block diagram of a system 10 that can implement one embodiment. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10 and a payroll rules engine 100 for populating payroll accounts, which is described in greater detail below. Additional, fewer, and/or different modules 18 may also be included in system 10. In one embodiment, payroll rules engine 100 is part of the “Oracle E-Business Suite Release 12” enterprise application system from Oracle Corp, or as part of an enterprise resource planning system.

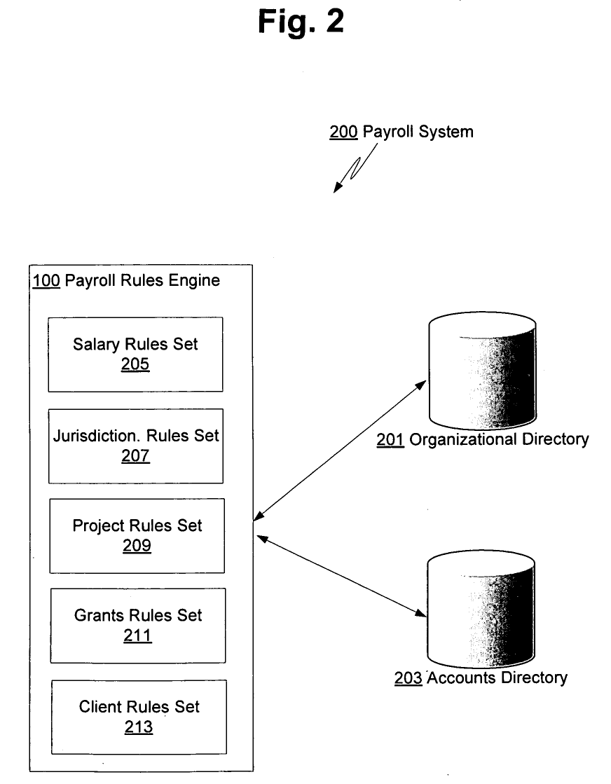

FIG. 2 is a block diagram of a payroll system 200 that includes payroll rules engine 100 in accordance with an embodiment. Payroll rules engine 100 works with organizational directory 201 and accounts directory 203 to automatically calculate payrolls and map payroll cost to specific accounts. Organizational directory 201 may include personnel information such as a list of employees and their home addresses, departments, positions, salary, fulltime status, etc. Accounts directory 203 may include a list of accounts including jurisdictional accounts, project accounts, client accounts, grants, etc. Payroll rules engine 100 may include a salary rules set 205 for calculating an employee salary elements such as regular salary, overtime salary, benefits, bonuses, etc. Payroll rules engine 100 may further include a jurisdictional rules set 207 for calculating jurisdictional tax elements such as federal tax, state tax, Medicare, health and welfare expenses, etc. Payroll rules engine 100 may further include a project rules set 209 for calculating how payroll costs should be attributed to various projects. Payroll rules engine 100 may further include a grants rules set 211 for calculating how payroll costs should be attributed to a grant account. Payroll rules engine 100 may further include a client rules set 213 for calculating how payroll costs should be billed to a client. One of ordinary skill in the art will recognize that the list of rules sets is not exhaustive, and further rules sets may be included in accordance with present and future-conceived uses of payroll rules engine 100.

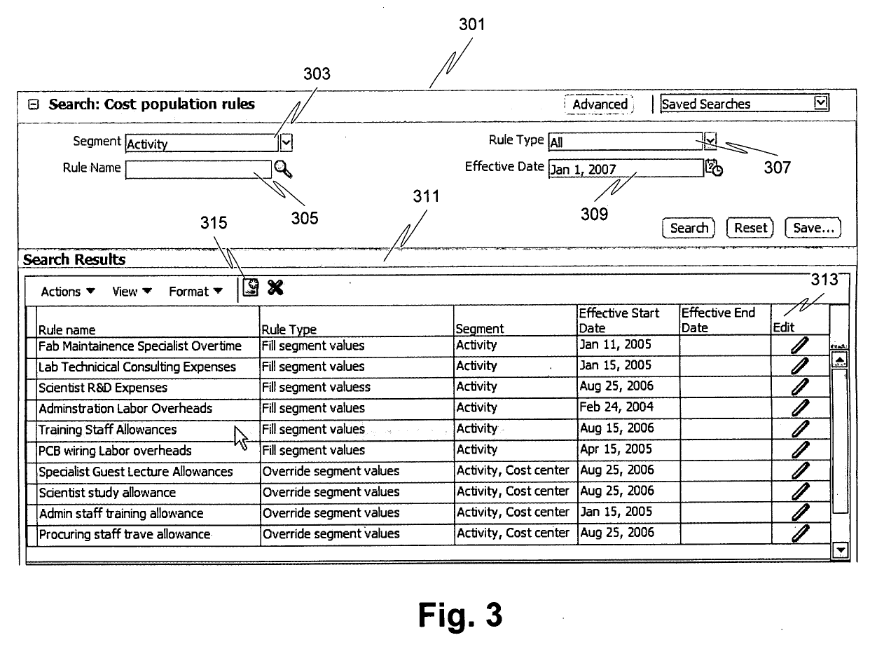

In one embodiment, a user interface (“UI”) for the payroll rules engine 100 has two pages: a search page for searching payroll rules and an edit page for creating and editing payroll rules. FIG. 3 is an example search UI 301 for the payroll rules engine 100 in accordance with an embodiment. Rules may be searched using a variety of criteria. Segment name search box 303 allows a user to search by segment. A segment is a component of the payroll account; for example, it could be an Activity or Cost Center. Activity and Cost Center may be examples of components in an accounting structure. For example, a Cost Center may represent an accounting unit where each department is a Cost Center. An Activity may represent an activity type for which account is created, such as a research project, training, student project etc. A payroll account can thus comprise of multiple segments, such as a segment for a department and a segment for training.

Rule type search box 307 allows a user to search by rule type. A rule type in this example can be a “Fill segment values” rule or “Override segment values” rule. Rule name search box 305 allows a user to search by a given name for a rule. Effective date search box 309 allows a user to search by a date on which the rule became active. The results of a search are displayed in results box 311. By clicking on edit button 313 or new rule button 315, a user is taken to an edit UI for rules creation and editing.

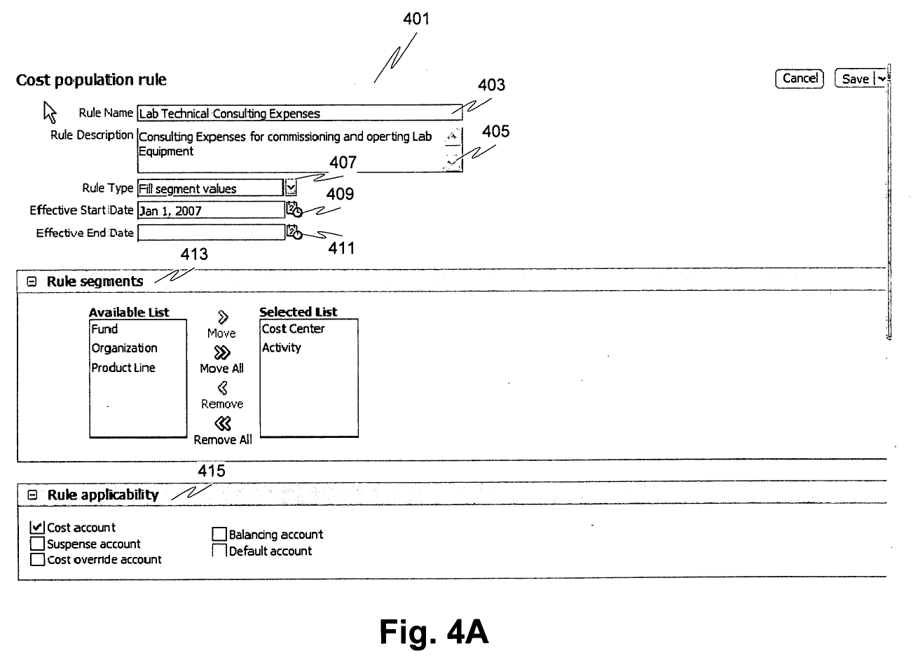

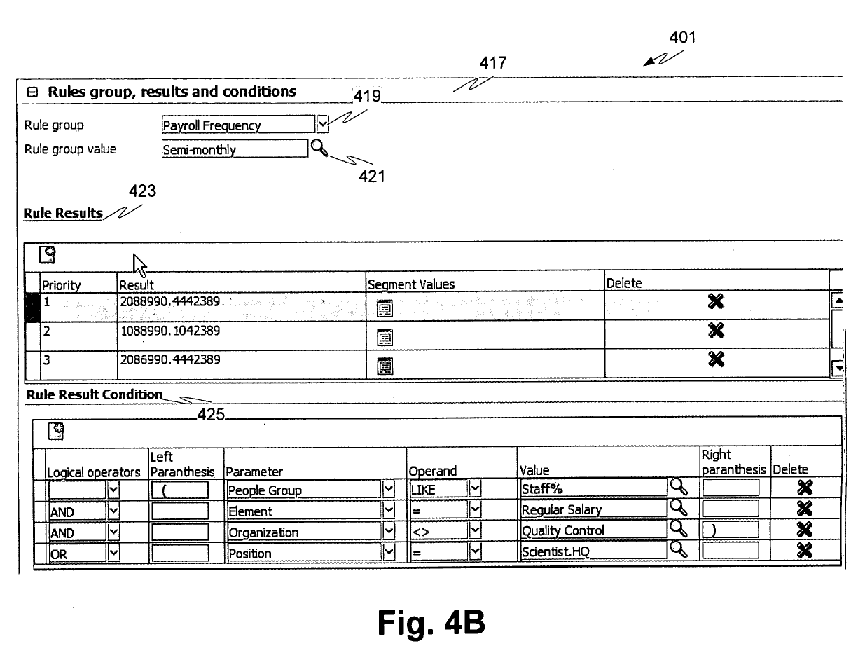

FIG. 4A illustrates an example edit UI 401 for payroll rules engine 100 in accordance with an embodiment. In creating or editing a rule, a user will enter a name for the rule in rule name box 403, a description for the rule in rule description box 405, a rule type (e.g., fill or override segment values) in rule type box 407, a date on which the rule is to be active in effective start date box 409, and a date on which the rule is to become inactive in effective end date box 411.

Rules segment section 413 allows a user to select the segments for which the segment values will be returned by the rule. In this example, the rule will return back the value for “Cost Center” and “Activity” segments. “Fund,” “Organization,” and “Product Line” segments are also included in the group from which the user may select. Rule applicability section 415 allows a user to select the account type for which the rules are applicable. In this example, rules can be setup to return segment values for one or more of the following account types: cost account, balancing account, suspense account, default account, and cost override account. A cost account, suspense account, default account, and cost override account may be examples of payroll expense account. A balancing account may be a counterpart account of the cost account in a double-entry accounting system.

Turning to FIG. 4B to illustrate the second half of edit UI 401, rule group section 417 allows a user to select the high level group to which the rules and conditions are applicable using rule group menu 419 and rule group value 421. In this example, the rule group is “Payroll Frequency” with a “Semi-monthly” value. That means that this rule is applicable for all payrolls with a semi-monthly run frequency. Other rule groups and value that may be selected include:

1. Payroll frequency—the frequency in which payroll is calculated, e.g., semi-monthly, monthly, weekly, etc.

2. Element classification—the classification of a payroll element such as earnings, deduction, benefit, etc.

3. Organization hierarchy—the human resources hierarchy of the organization such as Sales, Finance, Product Development, etc. An organization hierarchy may have multiple organizations within it.

Rule results section 423 includes the results returned by the rule if the rule result conditions match. The result may be an account number having one or more segments. Rule conditions section 425 allows the user to select the rule conditions that must be satisfied to return a selected result in the rule results section. In this example, the rules conditions depicted return the result “2088990.4442389.” The rule conditions can be defined for various parameters including the name of a person; the group a person optionally belongs to such as full time, part time, union, teaching staff, etc.; the department in which a person works; the position the person holds such as manager, developer, vice president, etc.; the payroll component of person's salary such as regular pay, overtime, per diem, etc. Complex rule conditions may be defined as logical expressions using AND and OR operators, as well as less than, equal to, and greater than operators. Left and right parentheses may be used to nest the conditions. If the rule conditions are not defined, the rule results may be applicable to the whole rule group. One of ordinary skill in the art will recognize that there are numerous parameters and values that could be used in accordance with an embodiment of payroll rules engine 100.

By way of example and not limitation, presented here are some rule conditions that are defined as logical expressions using AND and OR operators, as well as less than, equal to, and greater than operators. In the prior art, there was no simple way to create such expressions to return a value for a payroll account.

### EXAMPLE 1

This is an example of rule conditions returning a value of “123” for “Jurisdiction,” where jurisdiction is a component of the payroll account.

(Employee State=California AND

Employee County=San Mateo AND

Employee City=Redwood City)

### EXAMPLE 2

This is an example of rule conditions returning a value of “Training and Faculty Full Time” for “Expenditure Type,” where Expenditure Type is a component of the payroll account.

(Appointment Type=Teaching and Research OR

Appointment Type=Professional Research Staff) AND

(Employment Category=Fulltime OR

Employment Category=Part-time OR

Part-time FTE Percent>=80%)

### EXAMPLE 3

This is an example of rule conditions returning a value of “100.200.300.400” for the complete account.

(Grant Sponsor=National Institutes of Health AND

Award Type=Research)

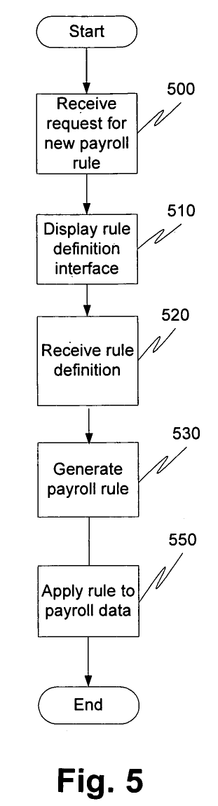

FIG. 5 illustrates a flow diagram of the functionality of payroll rules engine 100 in accordance with an embodiment. In one embodiment, the functionality of the flow diagram of FIG. 5 is implemented by software stored in memory and executed by a processor. In other embodiments, the functionality can be performed by hardware, or any combination of hardware and software. The payroll rules engine 100 receives a request from a user to create a new rule (500). Note, creating a new rule may be creating a rule from scratch, or searching for an existing rule and editing the existing rule. The payroll rules engine 100 then displays the edit UI 401 to allow the user to define the rule (510). The payroll rules engine then receives the rule definition (520), and generates the rule (530). The payroll rules engine then applies the rule to payroll data, such as data from the organizational and accounts directories (540).

Accordingly, complex payroll costing scenarios are easily automated. Consider a scenario where the employee's salary expenses are charged to payroll accounts which are summarized to General Ledger accounts. In some situations, the jurisdiction is assigned an account number and is a component of the complete account. In the prior art, there was no automated way to assign an account number based on the employee's jurisdiction. Users simply maintained a custom program that changed the account based on the employee's jurisdiction.

Another scenario is where the payroll salary expenses are transferred to project expense account. To achieve this transfer, payroll salary elements (e.g., regular salary, overtime salary, benefits) are mapped to project expenditure types based on employee's department, position and job. In the prior art, users maintained a custom program for the mapping, rather than a generic solution as presented here.

Yet another scenario is where a grant will state that the grant money is only for the salary of the employee and not be charged for any fringe benefits. Fringe benefits for this case can be, but not limited to, Medicare, federal unemployment tax, state unemployment tax, and health and welfare expenses incurred by the employer. In many cases these expenditures range from 25-40% of salary expenditures. In this case, if the salary is being charged from an account, the fringe benefit should automatically be assigned to a different account. In the prior art, users manually ensured that the salary and fringe setup accounts are correct. Accordingly, the payroll solution described herein will save organizations time and money in managing payroll costing accounts.

Thus, systems and methods for using rules to populate a payroll costing account are presented. A user can easily define rules for populating a payroll costing account by selecting parameters and logical expressions to return a value for an account. Once defined, a payroll rules engine applies these rules to payroll data to automatically determine a payroll account or account segment to which the organization cost of the employee's pay should be billed, as well as what portion of the pay should be withheld for state and federal taxes, Medicare, garnishments, etc. Thus, this nonspecific approach to payroll costing requires much less time and human involvement than manually assigning costing codes to each payout.

Some embodiments of the invention have been described as computer-implemented processes. It is important to note, however, that those skilled in the art will appreciate that the mechanisms of the invention are capable of being distributed as a program product in a variety of forms. The foregoing description of example embodiments is provided for the purpose of illustrating the principles of the invention, and not in limitation thereof, since the scope of the invention is defined solely by the appended claims.

What is claimed is:

1. A method for using rules to populate a payroll cost account, comprising:
receiving a request to create a new payroll rule;
displaying a rule creation user interface to a user;
receiving a rule definition for the new payroll rule;
generating the new payroll rule; and
applying the payroll rule to payroll data.

2. The method of claim 1, wherein receiving the request to create the new payroll rule includes:
receiving search criteria for an existing payroll rule;
identifying the existing payroll rule based on the search criteria; and
receiving a request to edit the existing payroll rule.

3. The method of claim 1, wherein the rule creation user interface includes a rule identification section for submitting at least one of a rule name, rule description, rule type, effective start date, and account segment for the new payroll rule.

4. The method of claim 1, wherein the rule creation user interface includes a rule group section for assigning a rule group and rule group value to the new payroll rule.

5. The method of claim 1, wherein the rule creation user interface includes a rule conditions section for selecting rule conditions for the new payroll rule.

6. The method of claim 5, wherein the rule conditions include at least one parameter, at least one value, and at least one logical operator.

7. The method of claim 6, wherein the at least one parameter is one of employee name, employee group, employee department, employee position, and payroll element.

8. The method of claim 5, wherein the rule creation user interface includes a rule results section for designating a rule result to return when the rule conditions are satisfied.

9. The method of claim 1, wherein receiving a rule definition for the new payroll rule includes receiving rule information submitted by the user via the rule creation user interface.

10. The method of claim 1, wherein the payroll data includes organization data and account data.

11. A computer-readable medium having instructions stored thereon that, when executed by a processor, cause the processor to provide a method for using rules to populate a payroll cost account by:
receiving a request to create a new payroll rule;
displaying a rule creation user interface to a user;
receiving a rule definition for the new payroll rule;
generating the new payroll rule; and
applying the payroll rule to payroll data.

12. The computer-readable medium of claim 11, wherein receiving the request to create the new payroll rule includes:
receiving search criteria for an existing payroll rule;
identifying the existing payroll rule based on the search criteria; and
receiving a request to edit the existing payroll rule.

13. The computer-readable medium of claim 11, wherein the rule creation user interface includes a rule identification section for submitting at least one of a rule name, rule description, rule type, effective start date, and account segment for the new payroll rule.

14. The computer-readable medium of claim 11, wherein the rule creation user interface includes a rule conditions section for selecting rule conditions for the new payroll rule.

15. The computer-readable medium of claim 11, wherein receiving a rule definition for the new payroll rule includes receiving rule information submitted by the user via the rule creation user interface.

16. A system for providing role navigation design and verification, comprising:
a display for displaying a rule creation user interface to a user; and
a rules engine for receiving a rule definition for a new payroll rule, generating the new payroll rule, and applying the payroll rule to payroll data.

17. A system for providing role navigation design and verification, comprising:
means for receiving a request to create a new payroll rule;
means for displaying a rule creation user interface to a user;
means for receiving a rule definition for the new payroll rule;
means for generating the new payroll rule; and
means for applying the payroll rule to payroll data.

18. The system of claim 17, wherein the means for receiving a request to create the new payroll rule includes:
means for receiving search criteria for an existing payroll rule;
means for identifying the existing payroll rule based on the search criteria; and
means for receiving a request to edit the existing payroll rule.

19. The system of claim 17, wherein the rule creation user interface includes a rule identification section for submitting at least one of a rule name, rule description, rule type, effective start date, and account segment for the new payroll rule.

20. The system of claim 17, wherein the rule creation user interface includes a rule group section for assigning a rule group and rule group value to the new payroll rule.

21. The system of claim 17, wherein the rule creation user interface includes a rule conditions section for selecting rule conditions for the new payroll rule.

22. The system of claim 17, wherein receiving a rule definition for the new payroll rule includes receiving rule information submitted by the user via the rule creation user interface.

23. The system of claim 17, wherein the payroll data includes organization data and account data.
